(19) United States
(12) Patent Application Publication
(10) Pub. No.: US 2006/0292059 A1
(43) Pub. Date: Dec. 28, 2006

(54) Catalyst element and use thereof

(76) Inventor: Felice DiMascio, Rocky Hill, CT (US)

Correspondence Address: CANTOR COLBURN, LLP, 55 GRIFFIN ROAD SOUTH, BLOOMFIELD, CT, 06002, US

(21) Appl. No.: 11/414,936

(22) Filed: May 1, 2006

Related U.S. Application Data
(60) Provisional application No. 60/692,879, filed on Jun. 22, 2005.

(51) Int. Cl. B01J 29/00; B01J 29/18; B01J 29/08; B01J 21/16; B01J 21/18; B01J 27/128; B01J 31/00; B01J 27/24; B01J 27/138; B01J 27/06

(52) U.S. Cl. 423/477; 502/224; 502/226; 502/229; 502/77; 502/79; 502/80; 502/84; 502/78; 502/182; 502/183; 502/185; 502/200; 502/159; 502/325; 502/324

(57) ABSTRACT

A catalyst element includes a porous housing; a filter core disposed within the housing; and a filler material comprising a catalyst particle, a redox particle, an oxidizing particle, or a combination comprising at least one of the foregoing particles, wherein the filler material is disposed within the housing; wherein the catalyst element comprises a plurality of tortuous flow paths, through which a reactive mixture may flow and contact at least a portion of each of the housing, filter core, and filler material. The catalyst element may be useful in a variety of chemical processes including hydrogenation, dehydrogenation, hydrogenolysis, oxidation, reduction, alkylation, dealkylation, carbonylation, decarbonylation, coupling, isomerization, amination, deamination, or hydrodehalogenation.

### CROSS REFERENCE TO RELATED APPLICATIONS

This application claims the benefit of U.S. Provisional Patent Application Ser. No. 60/692,879, filed Jun. 22, 2005, which is incorporated herein by reference in its entirety.

### BACKGROUND

This disclosure generally relates to catalyst elements.

Catalysts, which may generally take the form of heterogeneous, homogeneous, or biological catalysts, are of significant importance to the chemical industry as evidenced by the fact that the great majority of all chemicals produced have been in contact with a catalyst at some point during their production. Despite the many advances in the areas of homogeneous and biological catalysis, heterogeneous catalysts remain the predominant form used by industry. Heterogeneous catalysts are favored in part because they tolerate a much wider range of reaction temperatures and pressures, they can be more easily and inexpensively separated from a reaction mixture by filtration or centrifugation, they can be regenerated, and they are less toxic than their homogeneous or biological counterparts.

A heterogeneous catalyst is generally a solid material that operates on reactions taking place in the gaseous or liquid state, and generally includes a reactive species and a support for the reactive species, which optionally may be porous. One problem associated with heterogeneous catalysts is desorption of the reactive species from the support. When the number of the catalyst's reactive species decreases, the catalyst is not as effective and the reaction rate and/or product selectivity is reduced. Another disadvantageous feature of heterogeneous catalysts is catalyst attrition through the release of catalyst fines, which are small particles of spent catalyst that can remain in the reaction mixture and/or pass into the products. The generation of catalyst fines can also have a deleterious effect on catalyst performance. Furthermore, removal of catalyst fines can become an expensive and/or time-consuming step during the production process. Yet another disadvantage of heterogeneous catalysts is bypassing or channeling of the catalyst by the reactant mixture. When the reaction mixture bypasses the catalyst, the reaction may not proceed as efficiently, product yield may decrease, and product contamination may occur. Yet still another disadvantage associated with heterogeneous catalysts is pressure drop. If the reactant mixture cannot pass through a catalyst chamber properly a pressure drop may occur and a large amount of power, which may be in the form of additional applied pressure, will be required to push the reactant mixture through the chamber.

Despite their suitability for their intended purposes, there nonetheless remains a need in the art for new and improved devices for use as heterogeneous catalysts. It would be particularly advantageous if such catalyst devices could eliminate or result in decreased desorption of the reactive species from the support. It would further be advantageous if such catalyst devices eliminated or minimized release of catalyst fines, channeling or bypassing, and pressure drop.

### SUMMARY

A catalyst element includes a porous housing; a filter core disposed within the housing; and a filler material comprising a catalyst particle, a redox particle, an oxidizing particle, or a combination comprising at least one of the foregoing particles, wherein the filler material is disposed within the housing; wherein the catalyst element comprises a plurality of tortuous flow paths, through which a reactive mixture may flow and contact at least a portion of each of the housing, filter core, and filler material.

In another aspect, the catalyst element includes a porous cylindrical housing, wherein an end of the porous cylindrical housing is capped; a cylindrical filter core disposed within the housing; and a filler material comprising a catalyst particle, a redox particle, an oxidizing particle, or a combination comprising at least one of the foregoing particles, wherein the filler material is disposed within the housing; wherein the catalyst element comprises a plurality of tortuous flow paths, through which a reactive mixture may radially flow and contact at least a portion of each of the housing, filter core, and filler material.

A method for catalyzing a chemical process comprises flowing a reaction mixture through a catalyst element, wherein the catalyst element comprises a porous housing; a filter core disposed within the housing; and a filler material comprising a catalyst particle, a redox particle, an oxidizing particle, or a combination comprising at least one of the foregoing particles, wherein the filler material is disposed within the housing; wherein the catalyst element comprises a plurality of tortuous flow paths, through which the reactive mixture flows; and increasing a reaction rate for the reaction mixture to produce a product.

A method for producing chlorine dioxide comprises flowing an aqueous solution of chlorous acid into a catalyst element, wherein the catalyst element comprises a porous housing; a filter core disposed within the housing; and a filler material comprising a catalyst particle, a redox particle, an oxidizing particle, or a combination comprising at least one of the foregoing particles, wherein the filler material is disposed within the housing; wherein the catalyst element comprises a plurality of tortuous flow paths, through which the aqueous solution of chlorous acid flows; and contacting the aqueous solution of chlorous acid with the filler material to form chlorine dioxide in the aqueous solution.

The above described and other features are exemplified by the following figures and detailed description.

### BRIEF DESCRIPTION OF THE DRAWINGS

Referring now to the Figures, which are exemplary embodiments, and wherein the like elements are numbered alike:

FIG. 1 is a schematic representation of a cylindrical catalyst element; and

FIG. 2 is a schematic representation of a rectangular prismatic catalyst element.

### DETAILED DESCRIPTION

Disclosed herein are catalyst element devices and methods for using the catalyst elements. The catalyst element generally includes a housing and a filter core disposed within the housing. Also disposed within the housing is a filler material. The filler material may comprise a catalyst particle, a redox particle, an oxidizing particle, or a combination comprising at least one of the foregoing particles. The housing is sufficiently porous such that the assembled catalyst element (i.e., filler material and filter core within the housing) comprises a plurality of tortuous flow paths, through which a reactive mixture may flow and contact at least a portion of each component of the assembled catalyst element.

The term “catalyst” has its ordinary meaning as used herein, and generically describes a material which increases the rate of a chemical reaction but which is not consumed by the reaction. In addition, a catalyst affects only the rate of the reaction; it changes neither the thermodynamics of the reaction nor the equilibrium composition. Still further, as used herein to describe the catalyst elements or components of the catalyst elements, the term “catalyst” is intended to refer to heterogeneous catalysts, as opposed to homogeneous or biological catalysts.

The term “redox”, which is an abbreviation for reduction-oxidation, also has its ordinary meaning as used herein, and generically describes a material that can participate in such a reaction wherein one reactant becomes oxidized, while another becomes reduced and takes up the electrons released in the oxidation reaction. The term “oxidizing particle” is used herein to generically refer to a material that oxidizes a reactant. It is important to note that while the redox material and the oxidizing material may catalyze (i.e., increase the rate of) a chemical reaction, they are distinguished from a catalyst material herein in that they each may become consumed by the reaction, change the thermodynamics of the reaction, and/or change the equilibrium composition of the reaction.

Also, as used herein, the terms “first,” “second,” and the like do not denote any order or importance, but rather are used to distinguish one element from another, and the terms “the”, “a”, and “an” do not denote a limitation of quantity, but rather denote the presence of at least one of the referenced item. Furthermore, all ranges disclosed herein are inclusive of the endpoints and independently combinable. The modifier “about” used in connection with a quantity is inclusive of the stated value and has the meaning dictated by the context or includes at least the degree of error associated with measurement of the particular quantity.

The catalyst element may be of any shape or size effective for use in a reaction process. For example, the catalyst element may be cylindrical, rod-shaped, orthorhombic, cubic, conical, frustoconical, disc-shaped, spherical, or the like.

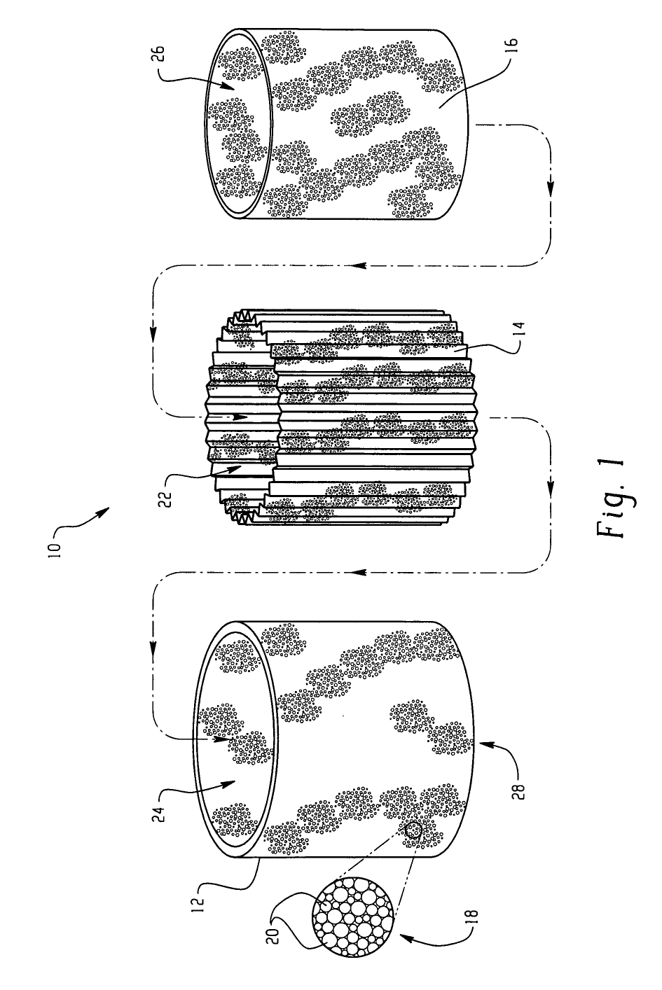

An exemplary catalyst element 10 is shown in FIG. 1. The housing 12, filter core 14, and consequently the catalyst element 10 are cylindrical. The filler material (not shown) may be disposed in an inner cylindrical section 24 between the housing 12 and the filter core 14. If the filter core 14 comprises pleats or layers of filter material, the filler material may be impregnated in between the pleats or layers of the filter material. If the catalyst element 10 is optionally capped with a plugging material (not shown) or pre-capped during fabrication, the filler material may be disposed in an inner cylindrical section 22 of the filter core 14.

The catalyst element 10 may optionally comprise an inner member 16, such that the filter core 14 is interposed between the housing 12 and the inner member 16. The inner member 16 is also sufficiently porous such that the flow of the reactive mixture through the plurality of tortuous flow paths is not substantially diminished. In addition to the different placement locations of the filler material described above, the filler material may also be disposed in an inner cylindrical section 26 of the inner member 16.

In an exemplary embodiment, the cylindrical catalyst element 10 is capped at one end 28, while the other end is left open and uncapped. With cylindrical catalyst element 10, the reaction mixture may flow through the tortuous flow paths 20 (one end of which are shown in inset 18) in a radial direction from outside to inside allowing the entire exterior surface of catalyst element 10 to contact the reaction mixture. The uncapped end may provide an outlet for a catalyzed reaction mixture. Alternatively, the reaction mixture may flow through the tortuous paths 20 (one end of which are shown in inset 18) from inside to outside, allowing the entire interior surface of catalyst element 10 to contact the reaction mixture. In this embodiment, the uncapped end provides an inlet for the reaction mixture. Dimensions such as length, inner diameter and outer diameter may readily be tailored toward the particular application. In one embodiment, the cylindrical catalyst element 10 has a length of about 5 to about 90 centimeters (cm), an inner diameter of about 0.2 to about 30 cm, and an outer diameter of about 5 to about 15 cm.

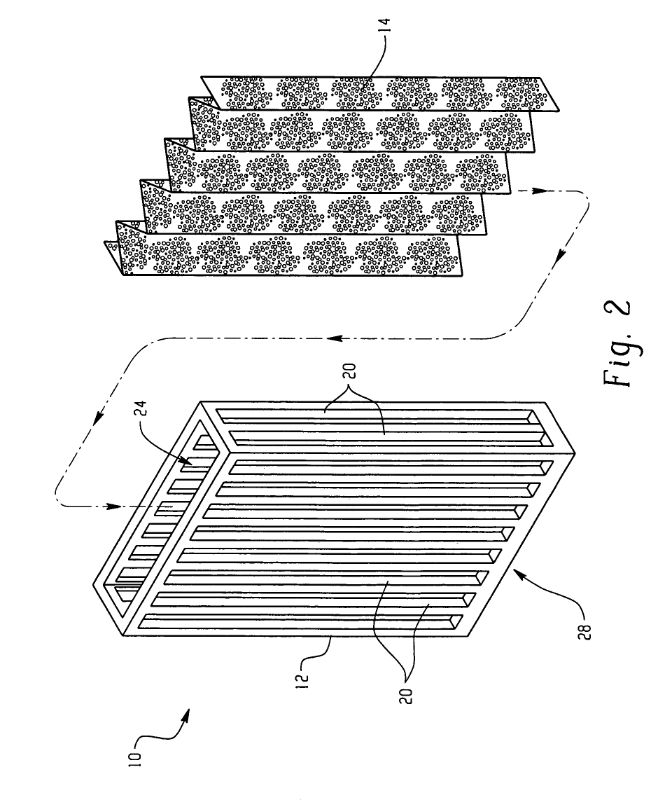

Another exemplary catalyst element 10 is shown in FIG. 2. In this embodiment, the housing 12, filter core 14, and consequently the catalyst element 10 are orthorhombic (i.e., rectangular prismatic). The filler material (not shown) may be disposed in an inner rectangular prismatic section 24 between the housing 12 and the filter core 14. If the filter core 14 comprises pleats or layers of filter material, the filler material may be impregnated in between the pleats or layers of the filter material. If the filter core 14 is hollow in the center (not shown) and the catalyst element 10 is optionally capped with a plugging material (not shown) or pre-capped during fabrication, the filler material may be disposed in an inner rectangular prismatic section (not shown) of the hollow filter core 14.

In one embodiment, the orthorhombic catalyst element 10 serves as a “membrane” through which the reaction mixture must pass. The reaction mixture flows through the tortuous flow paths 20 (one end of which are shown as rectangular slots) in a linear direction from a first side (not shown) of the catalyst element 10 to a second side (not shown) directly opposite to the first side.

In another embodiment, the orthorhombic catalyst element 10 is capped at one end 28, while the other end is left open and uncapped. With orthorhombic catalyst element 10, the reaction mixture may flow through the tortuous flow paths 20 (one end of which are shown as rectangular slots) from outside to inside allowing the entire exterior surface of catalyst element 10 to contact the reaction mixture. The uncapped end may provide an outlet for a catalyzed reaction mixture. Alternatively, the reaction mixture may flow through the tortuous paths 20 (one end of which are shown in inset 18) from inside to outside, allowing the entire interior surface of catalyst element 10 to contact the reaction mixture. In this embodiment, the uncapped end provides an inlet for the reaction mixture. Dimensions such as length, width, height, and inner perimeter (if the filter core 14 is hollow) may readily be tailored toward the particular application. In one embodiment, the orthorhombic catalyst element 10 has a length of about 5 to about 90 centimeters (cm), a width of about 0.2 to about 15 cm, and a height of about 5 to about 30 cm.

Although the tortuous paths 20 are shown as circles or rectangular slots, they may be any shape as determined by particle-particle interstices created within the filler material; the pore shape of the housing 12, filter media 14, and/or optional inner member 16; and/or the particular dimensions of the catalyst element 10. However, in order to prevent any loss of filler material, the tortuous flow paths 20 must be smaller in dimension than the specific filler material used.

Suitable materials for making the housing 12, filter media 14, optional inner member 16, and/or optional end cap include polyethylene, polypropylene, epoxies, ethylene tetrafluoroethylenes, ethylene/tetrafluoro ethylene copolymers, ethylene/trifluorochloroethylene copolymers, etylene tetrafluoride-propylene/hexafluoride copolymers, perfluopromethylalkoxys, perfluoropropylalkoxys, phenolics, polyacetals, polyacrylics, polyalkyls, polyamideimides, polyamides, polyanhydrides, polyaramides, polyarylates, polyarylsulfones, polybenzimidazoles, polybenzothiazinophenothiazines, polybenzothiazoles, polybenzoxazoles, polybutadiene, polycarbonates, polychloro-trifluoroethylene, polychlorotrifluoroethylenes, polydibenzofurans, polydioxoisoindolines, polyesters, polyether etherketones, polyether ketone ketones, polyetherimides, polyetherketones, polyethersulfones, polyethylenimine, polyhexafluoropropylene-co-tetrafluoroethylenes, polyimides, polyisoprene, polymethacrylonitrile, polymethyl acrylates, polymethyl methacrylates, polyolefins, polyoxabicyclononanes, polyoxadiazoles, polyoxindoles, polyoxoisoindolines, polyphenylene sulfides, polyphosphazenes, polyphthalides, polypiperazines, polypiperidines, polypyrazinoquinoxalines, polypyrazoles, polypyridazines, polypyridines, polypyromellitimides, polyquinoxalines, polysilazanes, polysiloxanes, polystyrene, polysulfides, polysulfonamides, polysulfonates, polysulfones, polytetrafluoroethylenes, polythioesters, polytriazines, polytriazoles, polyureas, polyurethanes, polyvinyl acetate, polyvinyl alcohols, polyvinyl esters, polyvinyl ethers, polyvinyl halides, polyvinyl ketones, polyvinyl nitriles, polyvinyl thioethers, polyvinylidene fluoride, polyvinylpyrrolidone, vinylidene fluoride/hexafluoropropylene copolymers, vinylidene fluoride/tetrafluoroethylene copolymers, and the like, and combinations comprising at least one of the foregoing polymeric materials.

In one embodiment, the catalyst particle comprises a reactive species and a support. Desirably, the reactive species is disposed onto a surface of the support through chemisorption or physisorption. The reactive species is desirably in fluid communication with the plurality of tortuous flow paths. Optionally, the catalyst particle may further comprise a promoter and/or an ion exchange material, which may or may not be in fluid communication with the plurality of tortuous flow paths.

The term “reactive species” is used herein for convenience to refer generically to an active component of the catalyst during a chemical reaction process. The term “promoter” has its ordinary meaning as used herein and generally describes a material that is not catalytically active by itself but, when in the presence of the reactive species, enhances the performance of the reactive species. The term “support” has its ordinary meaning as used herein and generally describes an inactive component of the catalyst during the chemical reaction process.

In one embodiment, the reactive species comprises a metal or metal oxide, comprising an element of Groups 3-10 and 14 of a Periodic Table of Elements. Specifically, the reactive species may comprise a precious metal or precious metal oxide. Precious metals include the elements of Groups 8, 9, and 10 of the Periodic Table of Elements. In one exemplary embodiment, the reactive species is a platinum oxide.

When the reactive species comprises a metal oxide, the metal of the metal oxide is desirably in its highest possible oxidation state. In another embodiment, for metals with multiple oxidation states, the metal of the metal oxide may be partially oxidized. For example, with platinum oxides, platinum may be in the 2⁺ and/or in the 4⁺ oxidation state.

In one embodiment, the reactive species is in the form of fine powder particles. In another embodiment, the reactive species is in the form of coarse powder particles. Alternatively, the reactive species may be a mixture of fine and coarse powder particles. An average particle size of the reactive species is less than or equal to about 420 micrometers (40 U.S. mesh). More preferably the average particle size of the reactive species is less than or equal to about 177 micrometers (80 U.S. mesh).

The support may be a dense or porous solid. If the support is porous, the surface onto which the reactive species is adsorbed may include any internal pore surface. The support may be spherical (i.e., spheres or microspheres) or non-spherical (i.e., granules, pellets, powders, monoliths, extrudates, or cylinders).

A suitable support material may exhibit a wide range of chemical and structural properties and comprises materials such as silica, alumina, oxides, mixed oxides, zeolites, carbonates, clays, ceramics, and carbons. Suitable oxides include for example oxides of titanium, aluminum, niobium, silicon, zinc, zirconium, cerium and the like. Examples of suitable mixed oxides include alumina-titania, alumina-zirconia, ceria-zirconia, ceria-alumina, silica-alumina, silica-titania, silica-zirconia, and the like. Suitable zeolites include any of the more than about 40 known members of the zeolite group of minerals and their synthetic variants, including for example Zeolites A, X, Y, USY, ZSM-5, and the like, in varying Si to Al ratios. Suitable carbonates include for example carbonates of calcium, barium, strontium, and the like. Examples of suitable clays include bentonite, smectite, montmorillonite, paligorskite, attapulgite, sepiolite, saponite, kaolinite, halloysite, hectorite, beidellite, stevensite, fire clay, ground shale, and the like. Examples of suitable ceramics include earthy or inorganic materials such as silicon nitride, boron carbide, silicon carbide, magnesium diboride, ferrite, steatite, yttrium barium copper oxide, anthracite, glauconite, faujasite, mordenite, clinoptilolite, and the like. Suitable carbons include for example carbon black, activated carbon, carbon fibrils, carbon hybrids, and the like.

An average particle size of the support is about 0.1 to 30.0 millimeters (mm). More preferably average particle size of the support is about 0.25 to 0.85 mm. An average pore volume of the support is about 0.001 to about 5.0 cubic centimeters per gram (cm³/g). More preferably, the average pore volume of the support is about 0.01 to about 1 cm³/g. An average surface area of the support is about 1 to about 10,000 meters squared per gram (m²/g). More preferably, the average surface area of the support is about 100 to about 1500 m²/g.

Of these supports, ceramics are preferred. In one embodiment, the support is formed from those ceramics described in U.S. Pat. No. 4,725,390 and/or 4,632,876, herein incorporated by reference in their entireties. Other preferred ceramics are those made essentially from nonmetallic minerals (such as mineral clays) by firing at an elevated temperature. More preferred are ceramic materials commercially available under the trade name MACROLITE® by the Kinetico Company. The MACROLITE® ceramic materials are spherically shaped and characterized by having a rough texture, high surface area, and level of moisture absorption of less than about 0.5%. The low level of moisture absorption allows for a reactive species or reactive species precursor to penetrate a minimal depth into the surface of the ceramic, thereby disposing the reactive species onto a surface of the support, an optimum location for subsequent contact with a reaction mixture. The surface area of the MACROLITE® ceramic materials is believed to be about 103 m²/g.

Optionally, the catalyst particle may further comprise a promoter, wherein the promoter is a different material or composition than the reactive species. Suitable promoters include compositions comprising a Group 3-7 or 14 element or Rare Earth element of the Periodic Table of Elements, or a combination comprising at least one of the foregoing elements. Rare Earth elements include lanthanum, actinium, the Lanthanide series, and the Actinide series. Preferred promoters are Rare Earth oxides, including for example lanthanum, cerium, neodymium, and thorium oxides. In one embodiment, the promoter is in the form of fine powder particles. In another embodiment, the promoter is in the form of coarse powder particles. Alternatively, the promoter may be a mixture of fine and coarse powder particles. An average particle size of the promoter is less than or equal to about 420 micrometers (40 U.S. mesh). More preferably the average particle size of the promoter is less than or equal to about 177 micrometers (80 U.S. mesh). A molar ratio of the reactive species to the promoter is preferably about 0.3:1 to about 100:1. More preferably, the molar ratio of the reactive species to the promoter is about 10:1.

Optionally, the catalyst particle may further comprise an ion exchange material (i.e., a natural or synthetic material that can undergo an ion exchange reaction), wherein the ion exchange material is different from the support. Ion exchange materials include, for example, ion exchange coals, mineral ion exchangers, synthetic inorganic ion exchangers, organic ion exchangers or the like, or a combination comprising at least one of the foregoing ion exchange materials. Suitable ion exchange coals include, for example, coals comprising weak acid moieties, such as a carboxylic acid functional group. Suitable mineral ion exchangers include, for example, ferrous aluminosilicates with cation exchange properties, (e.g., analcite, chabazite, glauconites, harmotome, heulandile, natrolite, montmorillonite, beidellite, and the like) or aluminosilicates with anion exchange properties (e.g., apatite, hydroxyapatite, monotmorillonite, kaolinite, feldspars, sodalites, cancrinites, and the like). Examples of suitable synthetic inorganic ion exchangers include microcrystals embedded in a porous clay binder, such as prepared by combining oxides of Groups 4 of the Periodic Table with oxides of Groups 5 and/or 6 and embedding them in the clay binder. Suitable organic ion exchangers include polyelectrolytes such as phenols, styrenes, or acrylates with cation exchange moieties (e.g., sulfonic acid group, carboxylic acid group, or the like) or anion exchange moieties (e.g., trimethylammonium group, dimethylethanolammonium group, or the like).

An average particle size of the ion exchange material is 0.1 to 30.0 mm. More preferably average particle size of the ion exchange material is about 0.25 to 0.85 mm. When the ion exchange material is an organic ion exchanger it further comprises a crosslinking agent, wherein the crosslinking agent is in an amount of about 4 to about 55% wt of the total ion exchange material used. In one embodiment, a copolymer of styrene and divinylbenzene (DVB), where DVB is known as the crosslinking agent, is used; and DVB comprises about 4 to about 55% wt of the copolymer.

The reactive species, and/or the optional promoter, and/or the optional ion exchange material, may be disposed onto the surface of the support by any of a number of techniques including for example impregnation, co-precipitation, deposition-precipitation, ion-exchange, dipping, spraying, vacuum deposition, adhesion, chemical bonding, or the like, or a combination comprising at least one of the foregoing disposing techniques.

The reactive species of each of the plurality of catalyst particles may be activated before or after formation of the mixture or before or after formation of the catalyst element. The reactive species may be activated from about 100 to about 850 degrees Celsius (° C.). Activation of the reactive species may take from about 10 to about 240 minutes. Activation of the reactive species may be carried out, for example, in the presence of air, oxygen, water, hydrogen, or the like, or a combination comprising at least one of the foregoing.

Suitable materials for use as the redox particle include manganese dioxide-based minerals such as those commercially available under the trade names MANGANESE GREENSAND®, BIRM®, PYROLOX®, and MTM® from the Clack Corporation (Windsor, Wisc.). Other suitable redox particle materials include copper-zinc alloys such as those commercially available under the trade name KDF-85® from Fluid Treatment, Inc. (Three Rivers, Mich.). Still other suitable redox particle materials include iron hydroxides such as those commercially available under the trade name GFH® from USFilter (Ames, Iowa).

Suitable oxidizing particle materials include halogen (e.g., fluorine, chlorine, bromine, and iodine) sources, chalcogen (e.g., sulfur, selenium, and tellurium) sources, and the like. Specific chlorine sources may be soluble chlorine or chlorine-containing materials such as sodium hypochlorite, calcium hypochlorite, lithium hypochlorite, chlorinated isocyanurates (e.g., dichloroisocyanurate and trichloroisocyanurate), and the like. Specific bromine sources may be soluble bromine or bromine-containing materials such as 1-bromo-3-chloro-5,5-dimethyl hydantoin, 3-bromochloro-5,5-dimethyl hydantoin, 1,3-bromo-5,5-dimethyl hydantoin, 2-bromo-2-nitropropane-1,3-diol, 1,2-dibromo-2,4-dicyanobutane, 2,2-dibromo-3-nitrilopropionamide, and the like. Specific sulfur sources inlcude sodium peroxosulphate and the like.

An average particle size of the filler material is about 0.01 to about 50 mm. In one embodiment, the average particle size of the filler material is about 0.95 to about 15.9 mm. In another embodiment, the average particle size of the filler material is about 1.8 to about 5.5 mm.

If the filler material includes a particle that is at least partially consumed by the reaction, then the reaction rate is desirably greater than the erosion rate of the filler material. In one embodiment, the ratio of the rate of erosion of the filler material to the volumetric flow rate of the reactant mixture should be less than about 10:1. Preferably, this ratio is between about 0.5:1 to about 5:1, and more preferably is between about 0.75 to about 1.25.

The solid fraction, or the volume of filler material divided by the total volume of the housing minus the filter core, may be about 30 to about 90%. In one embodiment, the solid fraction is about 40 to about 80%. In another embodiment, the solid fraction is about 55 to about 75%.

It should be recognized by those skilled in the art that the catalyst elements 10 described herein advantageously also function as filtering devices. In one embodiment, the catalyst element 10 filters all or substantially all particulates of about 0.5 to about 100 micrometers. In another embodiment, the catalyst element 10 filters all or substantially all particulates less than about 10 micrometers.

Furthermore, it should be recognized by one of ordinary skill in the art that because the entire surface of the catalyst element 10 contacts the reaction mixture bypassing or fluidizing of the tortuous paths 20 of the catalyst element 10 by the reaction mixture is effectively eliminated and any pressure drop that may occur is reduced. In one embodiment, the pressure drop through the catalyst element 10 is about 0.1 to about 50 pounds per square inch (psi). In another embodiment, the pressure drop is less than about 5 psi.

The catalyst elements described herein are further advantageous in that they may be used in numerous chemical reaction processes, including among others hydrogenation, dehydrogenation, hydrogenolysis, oxidation, reduction, alkylation, dealkylation, carbonylation, decarbonylation, coupling, isomerization, amination, deamination, hydrodehalogenation, or the like.

An exemplary process of use is the oxidative production of a halogen oxide from an alkali metal halite solution. One such process generally comprises employing a cation exchange column for producing an aqueous effluent containing halous acid from the alkali metal halite solution, which is then fed to a catalytic reactor containing the catalyst element for converting the halous acid to halogen oxide. A second such process generally comprises employing an electrochemical acidification cell for producing an aqueous effluent containing a halous acid from the alkali metal halite solution, which is then fed to a catalytic reactor containing the catalyst element for converting the halous acid to halogen oxide. A third such process generally comprises mixing an alkali metal halite solution and a mineral acid, which is then fed to a catalytic reactor containing the catalyst element for converting the halous acid to halogen oxide. In one exemplary embodiment, the catalyst element may be used in the production of chlorine dioxide from an alkali metal chlorite solution.

This disclosure is further illustrated by the following non-limiting examples.

In these examples, which are directed towards the production of chlorine dioxide using the catalyst elements disclosed herein, the following parameters were recorded: chlorine dioxide flow rate, concentration, pH, and temperature as well as sodium chlorite and mineral acid flow rates.

A properly calibrated Direct Reading Spectrophotometer, Model No. DR/2010, was used to measure the chlorine dioxide concentration (mg/L) in the catalytic reactor effluent solution using Hach Company Method 8138. Measurement of the yield provided a standard for evaluating actual performance of the process/system and was determined in accordance with the following mathematical relationship:

$$\% Yield = \frac{actual}{theoretical} \times 100$$

wherein the actual yield was obtained from the amount of chlorine dioxide generated, and wherein the theoretical yield was calculated by the amount of chlorine dioxide that could be generated from the concentration of the sodium chlorite in the starting solution. The theoretical yield was calculated using the following mathematical relationship:

$$\% TheoreticalYield = \frac{{[ {ClO}_{2} ]}_{product}}{{[ \frac{X}{Y} ] [ {NaClO}_{2} ]}_{feed}} \times 100$$

wherein the X is the number of moles of chlorine dioxide produced and Y is the number of moles of chlorite ions required to produce X moles of chlorine dioxide based on the stoichiometry of the particular reaction.

In these examples, a DURAPORE® TPE cartridge filter (CVHI01TPE), as obtained from Mykrolis Corporation (Billerica, Mass.), served as the housing and filter core of the catalyst element. The housing was made from polypropylene and the filter core was made from a cylindrical polyvinylidene fluoride (PVDF) membrane. The cartridge filter had a cap at one end, with the other end having a 222 connector (VITON® fluoroelastomer o-ring) configuration. The cartridge filter had a retention rating of 0.45 micrometers (μm), a diameter of 2.75 inches (7.4 cm) and a length of 10 inches (25.4 cm).

### EXAMPLE 1

### Catalyst Particle Filled Catalyst Element

In this example, the filler material consisted of supported platinum oxide catalyst particles. The inner cylindrical section of the filter core was filled with about 250 cubic centimeters (cm³) of the filler material. Three types of catalyst particles were evaluated, with the difference between the three types being the size of the support used. MACROLITE® ceramic supports, as obtained from Kinetico, Incorporated (Newbury, Ohio), were used, with size ranges of about 0.25 to about 0.35 millimeters (mm) (ML4060), about 0.6 to about 1.4 mm (ML1430), and about 2.8 to about 5.7 mm (ML357).

To place the platinum on the surface of the ceramic support, about 37 milliliters (mL) of a precursor solution was made by dissolving about 1.1 grams (g) of tetraamineplatinum (II) chloride crystals in about 1.0 mL of 30% ammonia hydroxide and about 36 mL of 60% isopropyl alcohol at about 35 degrees Celsius (° C.), such that the solution contained about 0.6 grams of platinum. The precursor solution was then sprayed in a fine mist onto the surface of about 250 cm³ of ceramic support so as to form an even coating on the surface of the support. The coated ceramic support was dried, placed in a ceramic crucible, and calcined in an oxygen-containing environment at about 450° C. for about 60 minutes. Unless stated otherwise, the quantity of platinum on the support was about 0.5% by weight, based on the total weight of the catalyst particles.

The catalyst element (i.e., the catalyst particle filled cartridge filter) was installed in a 10-inch polypropylene vessel. Water flowed, within the polypropylene vessel, into the open end of the catalyst element, through the catalyst particles and filter core, and out of the housing. The flow rate through the catalyst element was controlled by a needle valve. Two peristaltic pumps were used to independently inject a 25% sodium chlorite (NaClO₂) and a 22% hydrochloric acid (HCl) solution into the vessel upstream of the catalyst element. Each catalyst element was operated for two hours.

The % Yield calculation was based on the following reaction:
5 NaClO₂+4 HCl→4 ClO₂+5 NaCl+2H₂O (1)

wherein five moles of NaClO₂ (Y) was required to make four moles of ClO₂ (X). Table 1 illustrates the results of these experiments.

TABLE 1
Catalyst Particle Filled Catalyst Element Results

| | Support Material | | |
|---|---|---|---|
| | ML4060 | ML1430 | ML357 |
| ClO₂ Flow Rate (mL/min) | 195 | 208 | 200 |
| NaClO₂ Flow Rate (mL/min) | 0.91 | 0.98 | 0.98 |
| HCl Flow Rate (mL/min) | 0.96 | 1.00 | 1.00 |
| ClO₂ Concentration (ppm) | 699 | 654 | 700 |
| ClO₂ pH | 1.76 | 1.82 | 1.77 |
| ClO₂ Temperature (° C.) | 25.1 | 22.0 | 22.3 |
| % Yield | 83.0 | 76.8 | 79.0 |

The data in Table 1 indicate that support particle size does not have a significant effect on ClO₂ yield, and that high yields can be obtained using these catalyst elements regardless of the support size.

### EXAMPLE 2

### Redox Particle Filled Catalyst Element

In this example, PYROLOX®, which is about 75 to about 80% pyrolusite, a naturally mined ore of manganese dioxide (MnO₂), was used as the filler material. The PYROLOX®, as obtained from the Clack Corporation (Windsor, Wisc.), had a particle size of about 420 μm (U.S. mesh 40) to about 840 μm (U.S. mesh 20). The inner cylindrical section of the filter core was filled with about 250 cubic centimeters (cm³) of the filler material.

The catalyst element (i.e., the redox particle filled cartridge filter) was installed in a 10-inch polypropylene vessel. Water flowed, within the polypropylene vessel, into the open end of the catalyst element, through the redox particles and filter core, and out of the housing. The flow rate through the catalyst element was controlled by a needle valve. Two peristaltic pumps were used to independently inject a 25% sodium chlorite (NaClO₂) and an acid solution into the vessel upstream of the catalyst element. Each catalyst element was operated for two hours. Three different acid choices were tried, each with varying acid solution flow rates. The ratio of the concentration of the acid solution to that of the NaClO₂ solution was a stoichiometric 1:1.

The % Yield calculation was based on the following reaction:
2 NaClO₂+4 HA+MnO₂→2 ClO₂+Mn(A⁻)₂+2 Na(A⁻)+2H₂O (2)

wherein HA represents the acid and A⁻ represents the conjugate base of the acid; and one mole of NaClO₂ (Y) was required to make each mole of ClO₂ (X). Table 2 illustrates the results of these experiments.

TABLE 2
Redox Particle Filled Catalyst Element Results

| | Acid Type | | | | | | | |
|---|---|---|---|---|---|---|---|---|
| | HCl | HCl | H₂SO₄ | H₂SO₄ | H₃PO₄ | H₃PO₄ | H₃PO₄ | H₃PO₄ |
| ClO₂ Flow Rate (mL/min) | 149 | 150 | 149 | 145 | 146 | 149 | 148 | 147 |
| NaClO₂ Flow Rate (mL/min) | 0.59 | 0.59 | 0.59 | 0.59 | 0.59 | 0.59 | 0.59 | 0.59 |
| Acid Flow Rate (mL/min) | 0.56 | 1.12 | 0.56 | 1.12 | 0.56 | 1.12 | 1.68 | 2.80 |
| ClO₂ Concentration (ppm) | 582 | 615 | 585 | 574 | 286 | 344 | 404 | 429 |
| ClO₂ pH | 2.86 | 2.22 | 2.80 | 2.34 | 3.61 | 3.00 | 2.78 | 2.55 |
| ClO₂ Temperature (° C.) | 20.7 | 21.4 | 21.1 | 21.7 | 18.6 | 20.4 | 21.1 | 21.4 |
| % Yield | 65.2 | 69.3 | 65.8 | 62.6 | 31.4 | 38.5 | 45.0 | 47.4 |

As indicated in Table 2, for HCl and phosphoric acid (H₃PO₄), the yield increased as the acid flow rate was increased. In addition, yields were highest for HCl and sulfuric acid (H₂SO₄).

### EXAMPLE 3

### Oxidizing Particle Filled Catalyst Element

In this example, trichloroisocyanurate (C₃N₃O₃Cl₃) tablets were used as the filler material. The inner cylindrical section of the filter core was filled with about 11 one-inch tablets of the filler material.

The catalyst element (i.e., the oxidizing particle filled cartridge filter) was installed in a 10-inch polypropylene vessel. Water flowed, within the polypropylene vessel, into the open end of the catalyst element, through the oxidizing particles and filter core, and out of the housing. The flow rate through the catalyst element was controlled by a needle valve. Two peristaltic pumps were used to independently inject a 25% sodium chlorite (NaClO₂) and a HCl solution into the vessel upstream of the catalyst element. The ratio of the concentration of the HCl solution to that of the NaClO₂ solution was a stoichiometric 1:1. The catalyst element was operated for three hours, with measurements taken each hour.

It is important to note that additional acid was required to establish the proper reaction pH. The sodium chlorite solution and oxidizing particle tablets were received with inert ingredients that were alkaline in nature for stability purposes. These were neutralized with acid in order to lower the pH to optimum reaction conditions.

The % Yield calculation was based on the following reaction:
6 NaClO₂+3 HCl+C₃N₃O₃Cl₃→6 ClO₂+6 NaCl+C₃N₃O₃H₃ (3)

wherein one mole of NaClO₂ (Y) was required to make each mole of ClO₂ (X). Table 3 illustrates the results of this experiment.

TABLE 3
Oxidizing Particle Filled Catalyst Element Results

| | Time (hours) | | |
|---|---|---|---|
| | 1 | 2 | 3 |
| ClO₂ Flow Rate (mL/min) | 216 | 223 | 219 |
| NaClO₂ Flow Rate (mL/min) | 0.59 | 0.59 | 0.59 |
| HCl Flow Rate (mL/min) | 0.56 | 0.56 | 0.56 |
| ClO₂ Concentration (ppm) | 605 | 587 | 605 |
| ClO₂ pH | 2.59 | 2.67 | 2.80 |
| ClO₂ Temperature (° C.) | 25.1 | 25.0 | 25.3 |
| % Yield | 98.2 | 98.5 | 99.5 |

As can be observed from the data shown in Table 3, high yields were consistently able to be obtained with time.

### EXAMPLE 4

### Oxidizing Particle Filled Catalyst Element

In this example, granular dichloroisocyanurate (C₃Cl₂N₃NaO₃) was used as the filler material. The inner cylindrical section of the filter core was filled with about 150 cm³ of the filler material.

The catalyst element (i.e., the oxidizing particle filled cartridge filter) was installed in a 10-inch polypropylene vessel. Water flowed, within the polypropylene vessel, into the open end of the catalyst element, through the oxidizing particles and filter core, and out of the housing. The flow rate through the catalyst element was controlled by a needle valve. Two peristaltic pumps were used to independently inject a 25% sodium chlorite (NaClO₂) and a HCl solution into the vessel upstream of the catalyst element. The ratio of the concentration of the HCl solution to that of the NaClO₂ solution was a stoichiometric 1:1. The catalyst element was operated for three hours, with measurements taken each hour.

Similar to Example 3, additional acid was required to establish the proper reaction pH.

The % Yield calculation was based on the following reaction:
4 NaClO₂+2 HCl+C₃Cl₂N₃NaO₃→4 ClO₂+4 NaCl+C₃N₃O₃NaH₂ (4)

wherein one mole of NaClO₂ (Y) was required to make each mole of ClO₂ (X). Table 4 illustrates the results of this experiment.

TABLE 4
Oxidizing Particle Filled Catalyst Element Results

| | Time (hours) | | |
|---|---|---|---|
| | 1 | 2 | 3 |
| ClO₂ Flow Rate (mL/min) | 200 | 197 | 198 |
| NaClO₂ Flow Rate (mL/min) | 0.59 | 0.59 | 0.59 |
| HCl Flow Rate (mL/min) | 0.56 | 0.56 | 0.56 |
| ClO₂ Concentration (ppm) | 639 | 650 | 657 |
| ClO₂ pH | 2.97 | 3.02 | 3.12 |
| ClO₂ Temperature (° C.) | 26.1 | 25.2 | 25.6 |
| % Yield | 96.1 | 96.2 | 97.9 |

As can be observed from the data shown in Table 4, consistently high yields were again able to be obtained with time.

### EXAMPLE 5

### Oxidizing Particle Filled Catalyst Element

In this example, calcium hypochlorite (CaCl₂O₂) tablets were used as the filler material. The inner cylindrical section of the filter core was filled with about 13¾-inch tablets of the filler material.

The catalyst element (i.e., the oxidizing particle filled cartridge filter) was installed in a 10-inch polypropylene vessel. Water flowed, within the polypropylene vessel, into the open end of the catalyst element, through the oxidizing particles and filter core, and out of the housing. The flow rate through the catalyst element was controlled by a needle valve. Two peristaltic pumps were used to independently inject a 25% sodium chlorite (NaClO₂) and a HCl solution into the vessel upstream of the catalyst element. The ratio of the concentration of the HCl solution to that of the NaClO₂ solution was a stoichiometric 3:1. The catalyst element was operated for three hours, with measurements taken each hour.

Similar to Examples 3 and 4, additional acid was required to establish the proper reaction pH.

The % Yield calculation was based on the following reaction:
4 NaClO₂+4 HCl+CaCl₂O₂→4 ClO₂+2 NaCl+2H₂O+2 CaCl₂ (5)

wherein one mole of NaClO₂ (Y) was required to make each mole of ClO₂ (X). Table 5 illustrates the results of this experiment.

TABLE 5
Oxidizing Particle Filled Catalyst Element Results

| | Time (hours) | | |
|---|---|---|---|
| | 1 | 2 | 3 |
| ClO₂ Flow Rate (mL/min) | 216 | 223 | 219 |
| NaClO₂ Flow Rate (mL/min) | 0.59 | 0.59 | 0.59 |
| HCl Flow Rate (mL/min) | 0.56 | 0.56 | 0.56 |
| ClO₂ Concentration (ppm) | 605 | 587 | 605 |
| ClO₂ pH | 2.59 | 2.67 | 2.80 |
| ClO₂ Temperature (° C.) | 25.1 | 25.0 | 25.3 |
| % Yield | 98.2 | 98.5 | 99.5 |

Once again, consistently high yields were able to be obtained throughout the course of the experiment.

### EXAMPLE 6

### Oxidizing Particle Filled Catalyst Element

In this example, 1,3-dibromine-5,5-dimethyl-hydantoin (BrClC₅H₅N₂O₂) tablets were used as the filler material. The inner cylindrical section of the filter core was filled with about 10 one-inch tablets of the filler material.

The catalyst element (i.e., the oxidizing particle filled cartridge filter) was installed in a 10-inch polypropylene vessel. Water flowed, within the polypropylene vessel, into the open end of the catalyst element, through the oxidizing particles and filter core, and out of the housing. The flow rate through the catalyst element was controlled by a needle valve. Two peristaltic pumps were used to independently inject a 25% sodium chlorite (NaClO₂) and a HCl solution into the vessel upstream of the catalyst element. The ratio of the concentration of the HCl solution to that of the NaClO₂ solution was a stoichiometric 1:1. The catalyst element was operated for three hours, with measurements taken each hour.

Similar to Examples 3-5, additional acid was required to establish the proper reaction pH.

The % Yield calculation was based on the following reaction:
NaClO₂+BrClC₅H₆N₂O₂→ClO₂+NaCl+HBr+C₅H₅N₂O₂ (6)

wherein one mole of NaClO₂ (Y) was required to make each mole of ClO₂ (X). Table 6 illustrates the results of this experiment.

TABLE 6
Oxidizing Particle Filled Catalyst Element Results

| | Time (hours) | | |
|---|---|---|---|
| | 1 | 2 | 3 |
| ClO₂ Flow Rate (mL/min) | 193 | 197 | 196 |
| NaClO₂ Flow Rate (mL/min) | 0.59 | 0.59 | 0.59 |
| HCl Flow Rate (mL/min) | 0.56 | 0.56 | 0.56 |
| ClO₂ Concentration (ppm) | 634 | 638 | 670 |
| ClO₂ pH | 2.74 | 2.83 | 2.93 |
| ClO₂ Temperature (° C.) | 25.1 | 25.2 | 25.0 |
| % Yield | 91.9 | 94.5 | 98.5 |

Table 6 indicates that high ClO₂ yields, with slight increases as the experiment progressed, could be obtained.

### EXAMPLE 7

### Oxidizing Particle Filled Catalyst Element

In this example, powdered sodium peroxosulphate, or sodium persulphate, (Na₂S₂O₈) was used as the filler material. The inner cylindrical section of the filter core was filled with about 150 cm³ of the filler material.

The catalyst element (i.e., the oxidizing particle filled cartridge filter) was installed in a 10-inch polypropylene vessel. Water flowed, within the polypropylene vessel, into the open end of the catalyst element, through the oxidizing particles and filter core, and out of the housing. The flow rate through the catalyst element was controlled by a needle valve. Two peristaltic pumps were used to independently inject a 25% sodium chlorite (NaClO₂) and a HCl solution into the vessel upstream of the catalyst element. The ratio of the concentration of the HCl solution to that of the NaClO₂ solution was a stoichiometric 0.5:1. The catalyst element was operated for one hour.

Similar to Examples 3-6, additional acid was required to establish the proper reaction pH.

The % Yield calculation was based on the following reaction:
2 NaClO₂+Na₂S₂O₈→2 ClO₂+2 Na₂SO₄ (7)

wherein one mole of NaClO₂ (Y) was required to make each mole of ClO₂ (X). Table 7 illustrates the results of this experiment.

TABLE 7
Oxidizing Particle Filled Catalyst Element Results

| | |
|---|---|
| ClO₂ Flow Rate (mL/min) | 153 |
| NaClO₂ Flow Rate (mL/min) | 0.59 |
| HCl Flow Rate (mL/min) | 0.56 |
| ClO₂ Concentration (ppm) | 248 |
| ClO₂ pH | 3.23 |
| ClO₂ Temperature (° C.) | 16.9 |
| % Yield | 28.0 |

Table 7 clearly demonstrates the feasibility of using Na₂S₂O₈ as a filler material for the catalyst element in the production of ClO₂.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A catalyst element, comprising:
a porous housing;
a filter core disposed within the housing; and
a filler material comprising a catalyst particle, a redox particle, an oxidizing particle, or a combination comprising at least one of the foregoing particles, wherein the filler material is disposed within the housing;
wherein the catalyst element comprises a plurality of tortuous flow paths, through which a reactive mixture may flow and contact at least a portion of each of the housing, filter core, and filler material.

2. The catalyst element of claim 1, wherein the catalyst particle comprises a reactive species disposed on a surface of at least a portion of a support, and wherein the reactive species is in fluid communication with the plurality of tortuous flow paths.

3. The catalyst element of claim 2, wherein the reactive species comprises a metal or metal oxide comprising an element of Groups 3-10 and 14 of a Periodic Table of Elements.

4. The catalyst element of claim 3, wherein the reactive species comprises a precious metal.

5. The catalyst element of claim 4, wherein the reactive species further comprises a non-precious metal.

6. The catalyst element of claim 5, wherein a molar ratio of the precious metal to the non-precious metal is about 0.3:1 to about 100:1.

7. The catalyst element of claim 2, wherein the catalyst particle further comprises a promoter, wherein the promoter is a different material or composition than the reactive species.

8. The catalyst element of claim 7, wherein the promoter is in fluid communication with the plurality of tortuous flow paths.

9. The catalyst element of claim 2, wherein the catalyst particle further comprises an ion exchange material, wherein the ion exchange material is different from the support.

10. The catalyst element of claim 9, wherein the ion exchange material is in fluid communication with the plurality of tortuous flow paths.

11. The catalyst element of claim 1, wherein the redox particle comprises a manganese dioxide-based mineral, copper-zinc alloy, iron hydroxide, or a combination comprising at least one of the foregoing.

12. The catalyst element of claim 1, wherein the oxidizing particle comprises a halogen source, chalcogen source, or a combination comprising at least one of the foregoing.

13. A catalyst element, comprising:
a porous cylindrical housing, wherein an end of the porous cylindrical housing is capped;
a cylindrical filter core disposed within the housing; and
a filler material comprising a catalyst particle, a redox particle, an oxidizing particle, or a combination comprising at least one of the foregoing particles, wherein the filler material is disposed within the housing;
wherein the catalyst element comprises a plurality of tortuous flow paths, through which a reactive mixture may radially flow and contact at least a portion of each of the housing, filter core, and filler material.

14. The catalyst element of claim 13, wherein the catalyst particle comprises a reactive species disposed on a surface of at least a portion of a support, and wherein the reactive species is in fluid communication with the plurality of tortuous flow paths.

15. The catalyst element of claim 14, wherein the catalyst particle further comprises a promoter, an ion exchange material, or both, wherein the promoter is a different material or composition than the reactive species, and wherein the ion exchange material is different from the support.

16. The catalyst element of claim 13, wherein the redox particle comprises a manganese dioxide-based mineral, copper-zinc alloy, iron hydroxide, or a combination comprising at least one of the foregoing.

17. The catalyst element of claim 13, wherein the oxidizing particle comprises a halogen source, chalcogen source, or a combination comprising at least one of the foregoing.

18. A method for catalyzing a chemical process, comprising:
flowing a reaction mixture through a catalyst element, wherein the catalyst element comprises a porous housing; a filter core disposed within the housing; and a filler material comprising a catalyst particle, a redox particle, an oxidizing particle, or a combination comprising at least one of the foregoing particles, wherein the filler material is disposed within the housing; wherein the catalyst element comprises a plurality of tortuous flow paths, through which the reactive mixture flows; and
increasing a reaction rate for the reaction mixture to produce a product.

19. The method of claim 18, wherein the chemical process comprises hydrogenation, dehydrogenation, hydrogenolysis, oxidation, reduction, alkylation, dealkylation, carbonylation, decarbonylation, coupling, isomerization, amination, deamination, or hydrodehalogenation.

20. The method of claim 18, wherein the chemical process comprises oxidative production of a halogen oxide from an alkali metal halite solution.

21. The method of claim 18, further comprising simultaneously filtering the reaction mixture with the catalyst element.

22. A method for producing chlorine dioxide, comprising:
flowing an aqueous solution of chlorous acid into a catalyst element, wherein the catalyst element comprises a porous housing; a filter core disposed within the housing; and a filler material comprising a catalyst particle, a redox particle, an oxidizing particle, or a combination comprising at least one of the foregoing particles, wherein the filler material is disposed within the housing; wherein the catalyst element comprises a plurality of tortuous flow paths, through which the aqueous solution of chlorous acid flows; and
contacting the aqueous solution of chlorous acid with the filler material to form chlorine dioxide in the aqueous solution.

23. The method of claim 22, further comprising filtering the aqueous solution of chlorous acid with at least the filter core of the catalyst element.
